(19) United States
(12) Patent Application Publication
(10) Pub. No.: US 2024/0202066 A1
(43) Pub. Date: Jun. 20, 2024

(54) SYSTEMS AND METHODS FOR FAULT DETECTION AND MITIGATION USING ADAPTIVE AND REAL-TIME DEGENERACY

(71) Applicant: University of Cincinnati, Cincinnati, OH (US)

(72) Inventors: Corey L. Butts, Warren, OH (US); Rashmi Jha, Cincinnati, OH (US); Temesgen Messay Kebede, Dayton, OH (US); David Anthony Kapp, Miamisburg, OH (US)

(21) Appl. No.: 18/539,778

(22) Filed: Dec. 14, 2023

Related U.S. Application Data
(60) Provisional application No. 63/432,483, filed on Dec. 14, 2022.

(51) Int. Cl. G06F 11/07

(52) U.S. Cl. CPC G06F 11/0793; G06F 11/079

(57) ABSTRACT

Systems and methods disclosed herein provide training an artificial neural network (ANN) on buffered input and output samples of an original component within a system such that the ANN is configured to produce a degenerate component, the degenerate component configured to generate the same outputs as the original component; comparing the outputs from the original component to outputs of the degenerate component during actual component operation; and in the event of a failure of the original component, replacing the original component with the degenerate component.

### CROSS-REFERENCE TO RELATED APPLICATIONS

This application claims priority to U.S. Provisional Application Ser. No. 63/432,483 filed Dec. 14, 2022, the entire disclosure of which is hereby incorporated by reference.

### STATEMENT REGARDING FEDERALLY FUNDED RESEARCH OR DEVELOPMENT

This invention was made with government support under FA8650-18-C-1191 awarded by Air Force Research Laboratory (AFRL). The government has certain rights in the invention.

### FIELD

The present disclosure generally relates to systems and methods for fault mitigation, and more particularly, for fault mitigation using adaptive and real-time degeneracy.

### BACKGROUND

The avionics industry has become increasingly reliant on systems that utilize integrated circuits. Among the applications for such circuits is software defined radio (SDR), which is favored over analog radio for uses with high flexibility and complexity requirements. For critical applications like SDR, designing reliable and trustworthy hardware is very important. However, assuring trust in hardware designs and implementations is a challenging task as digital circuits are becoming much smaller in size and are relied on to perform extremely complex tasks. As complexity of these systems increases, it can be difficult to determine the trustworthiness of the system as it is impractical to exhaustively test the system, and a single fault within an array of billions of gates can compromise the functionality of the entire system. Additionally, there is increased reliance on the designing of hardware that raises risks of malicious trojans being inserted within their designs.

Still further, methods of combating hardware trojans focus solely on detection. Logic testing, side channel analysis, and reverse engineering either require a trojan-free copy or are time consuming and error-prone. While there may be algorithms that can detect hardware trojans, they do not actively mitigate the threat.

### SUMMARY

In one aspect, a detection and mitigation system may include an artificial neural network (ANN) that may be configured to create a degenerate component that is functionally identical but structurally different from an original component in the system and produces the same output as the original component. The ANN may be configured to compare outputs of the degenerate component to outputs of the original component. The ANN may be configured to replace the outputs of the original component with the outputs of the degenerate component when a difference between the outputs of the original component and the outputs of the degenerate component is detected.

In another aspect, a method of detecting a component failure in a digital system comprises training an artificial neural network (ANN) on buffered input and output samples of an original component within a system such that the ANN is configured to produce a degenerate component. The degenerate component may be configured to generate the same outputs as the original component. The method may include comparing the outputs from the original component to outputs of the degenerate component during actual component operation. The method may include, in the event of a failure of the original component, replacing the original component with the degenerate component.

In another aspect, provided is a non-transitory, computer-readable medium including instructions that, when executed by at least one processor, cause the at least one processor to perform one or more operations including training an artificial neural network (ANN) on buffered input and output samples of an original component within a system such that the ANN is configured to produce a degenerate component, the degenerate component configured to generate the same outputs as the original component; comparing the outputs from the original component to outputs of the degenerate component during actual component operation; and in the event of a failure of the original component, replacing the original component with the degenerate component.

These and other features and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic diagram of an example software defined radio system, according to one or more embodiments shown and described herein;

FIG. 2 depicts a schematic diagram of a modulated signal going through each stage of a digital down-converter, according to one or more embodiments shown and described herein;

FIG. 3 depicts a block diagram of a model architecture, according to one or more embodiments shown and described herein;

FIG. 4 depicts a plurality of graphs illustrating a loss over time plots, according to one or more embodiments shown and described herein;

FIG. 5 depicts a schematic diagram illustrating steps to determine component replacement in a system, according to one or more embodiments shown and described herein; and

FIG. 6 depicts a block diagram of a hardware configuration of a system, according to one or more embodiments shown and described herein.

### DETAILED DESCRIPTION

The systems and methods disclosed herein are configured for prevention and mitigation of malicious or unintentional disruption of computer hardware and software operation through the use of machine learning and artificial intelligence. Still further, the systems and methods are configured for modeling SDR behavioral modules in real time using ANNs. As disclosed herein, adaptive component-level degeneracy (ACD) involves the training of an ANN on the input and output signals of a “black-box” component within an SDR system. Once the ANN has learned the component functionality sufficiently, the ANN may be configured to detect when the component is malfunctioning by comparing its own output to the output of the component. If the component is malfunctioning, the ANN may be configured to autonomously replace the component within an SDR module in real-time to maintain its functionality, thus making the component artificially degenerate. As will be further discussed, the systems and methods disclosed herein may also evaluate performance of two different ANN architectures (the bidirectional recurrent neural network (BRNN) and the convolutional neural network (CNN)) at modeling various components within a simulated SDR module. Still further, the systems and methods disclosed herein may be implemented within a real-time SDR system implemented with GNU Radio Companion (GRC) on an SoC device.

In recent years, embedded systems have made a significant evolution in processing capability. With this, integrated circuits, such as field-programmable gate array (FPGA) and system on a chip (SoC), have become much more important for avionics applications. Software-defined radio (SDR), one of the various embedded systems that utilizes the advantages of FPGA and SoC, may be favored over traditional analog radio systems in applications that have high flexibility and complexity requirements. SDR systems have also been shown to be useful in military applications where their reconfigurability can be leveraged to make data transmission more robust, reliable, and secure. SDR may provide significant advantages over traditional analog radio systems but can be prone to genuine faults and trojan attacks. While efforts have been made to defend against hardware trojans, implementations may be confined to detection and may involve invasive reverse engineering techniques.

Moreover, hardware trojans may be made up of two separate mechanisms: a trigger, which is used to activate the trojan, and a payload, which executes a malfunction intended by the trojan. These trojans can modify the functionality of the original circuit for malicious purposes, such as accelerated device aging, leakage of sensitive data, and Denial of Service (DOS). For example, if a plane is flying in an airspace occupied by other aircrafts and a hardware trojan disables the SDR used for its communication system, a dangerous situation is created that may result in reduced security and the loss of lives. This is one of many detrimental scenarios that may arise from the existence of hardware trojans.

Hardware designers should consider these possibilities in order to pursue the goal of developing completely trustworthy systems, hence the need for trojan detection and mitigation techniques. Traditionally, researchers have explored the ideas of introducing redundancy at various levels in the hierarchy to design a resilient and trustworthy system. Particularly, triple modular redundancy (TMR) is a technique that involves implementing three copies of the same digital circuit and feeding the outputs into a voter circuit to determine which signal is most valid. TMR has been shown to increase system reliability, but is very costly, as a single circuit will now take up three times the amount of space that it normally would. Additionally, with the rise in malicious hardware exploits, TMR is not a viable option for trojan mitigation, as the voter circuit can become compromised in the same way as the original circuit.

Regarding TMR, work has been done to mitigate the area overhead issue with TMR by means of selective hardening. Selective TMR (STMR) is a method that has been proposed with the aim or reducing area overhead of typical TMR implementations. The idea behind STMR is to implement full TMR on portions if the circuit that are determined to be critical to the system functionality or more susceptible to error while leaving the rest of the circuit unprotected. This may reduce the overhead penalty imposed by TMR while meeting specified reliability levels, but ultimately sacrifices full circuit protection for the reduced complexity. Partial TMR (PTMR) is a method that uses approximate logic instead of the full circuit to implement the duplicate logic. This may allow for full coverage of the circuit and the reliability is shown to be very similar to full TMR, but the overhead compared to full TMR is only improved upon by about 10%. Additionally, none of these redundancy approaches addresses the issue of hardware trojans, as they can be injected into the replicated circuits as well.

Other work has been done, with varying levels of success, to combat the issue of hardware trojans, a majority of which only deals in detection. Trojan detection techniques generally can be separated into two categories: non-destructive and destructive. Regarding the former, non-destructive techniques can be done without any physical modification to the original integrated circuit. In some examples, two methods are logic testing, and side channel analysis (SCA). Both methods work well together since they make up for the flaws of each other. For example, logic testing is not effective at detecting presence of larger trojans whereas SCA is. However, the main issue with both, and with most non-destructive techniques, is that they require a “golden” version of a netlist (that is, a trojan-free version of the netlist).

On the other hand, regarding the latter, destructive techniques may require modification of the integrated circuit in order to physically observe its structure. Reverse engineering has been utilized to obtain internal images of the layers within the integrated circuit which are then classified as trojan-infected or trojan-free using K-means clustering. With this, a high level of accuracy may be achieved and does not require the use of a golden version of the netlist, but the process of reverse engineering may be time consuming and error prone.

In view of at least the above, the systems and methods disclosed herein provide techniques for implementing adaptive component level degeneracy (ACD) by training a machine learning algorithm, such as an artificial neural network, to recognize and replace attacked components in real-time. These techniques may adopt a biological mechanism of degeneracy to create degenerate components which may produce the same outputs as the original through different means. By way of example, and without limitation, the systems and methods disclosed herein may focus on a DoS type of attack due to the severity of effects that it can have in SDR applications.

As referred to herein, “degeneracy” is defined to mean the ability of structurally different elements within a system to achieve the same functionality. The biological concept of degeneracy may refer to the ability for multiple, structurally different components of a system to perform the same function or produce the same output. This feature allows biological systems to be resilient to attacks and malfunction as degenerate functionalities can be achieved through multiple other components when one is not working correctly. The systems and methods disclosed herein may be configured to create ACD in computer systems, which may be referred to as artificial degeneracy, which may mimic biological processes. Interestingly, unlike digital systems, biological systems can seamlessly use the mechanism of degeneracy for reliable detection of threat and mitigation. Biological neural networks are an example of a degenerate system, as different neural structures within the brain can influence the same motor outputs.

To make a component degenerate, an artificial neural network (“ANN”) may be trained on the input and output of an original component until it is capable of approximating its functionality. The ANN may be configured to approximate functionality when it creates the same output as the original component with any given input. When trained, the ANN may be configured to detect abnormalities in the output of the original component by, for example, computing a mean squared error between the output of the ANN and the output of the original component. If the error is abnormally high, the ANN may be configured to replace the output of the original component output with its own ANN generated output, thereby making the component degenerate.

In certain embodiments, the component on which the ANN may be trained may be a black box in an embedded system for SDR, which produces a causal time series output from a given input. It is understood that the systems and methods disclosed herein may be implemented on both software and hardware components.

As further disclosed herein, the systems and methods provide a trojan and fault detection and mitigation technique, such as ACD, that is configured to utilize a machine learning model to learn the functionality of an SDR component. Once trained, the model may be configured to not only detect when the component is compromised, but also mitigate the issue with its own output. In certain embodiments, the model may be configured to effectively detect and mitigate a denial of service (DOS) trojan for a plurality of SDR components. In certain embodiments, different model variations, such as utilizing a one-dimensional convolutional neural network (CNN) architecture and a bidirectional recurrent neural network (BRNN) architecture, may be evaluated and compared. The performance of the ACD on a real-time SDR system implemented in GNU Radio Companion (GRC) may also be evaluated, with results showing potential for the future of utilizing ML techniques for hardware trojan defense. For devices operating in environments with higher levels of radiation (e.g., outer space, nuclear disaster sites, etc.), single-event upset (SEU) error can also occur, which may be when ionizing particles cause the unintentional state change of a sensitive node within an integrated circuit.

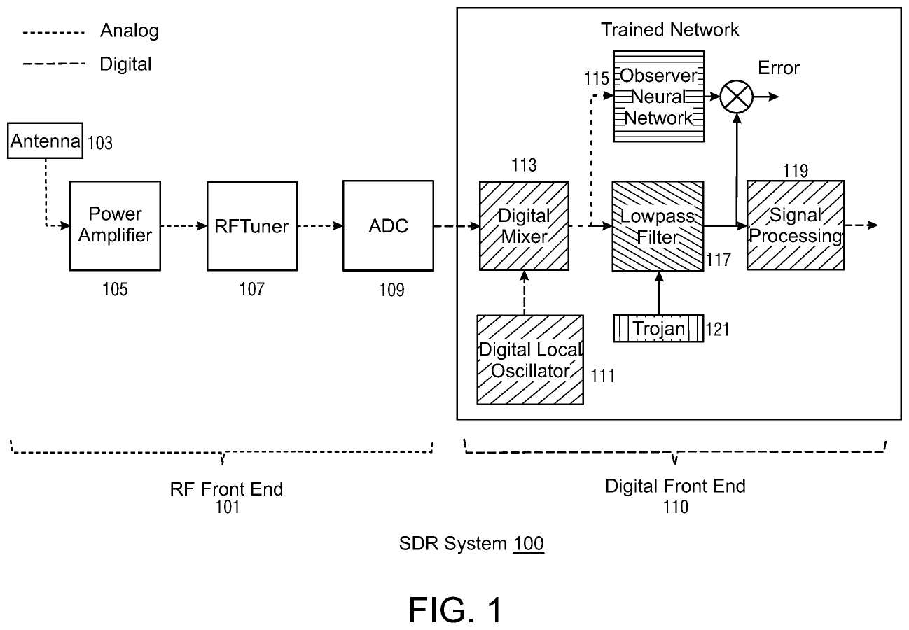

FIG. 1 depicts a schematic diagram of an example SDR system 100. As illustrated in FIG. 1, the SDR system 100 may include a first front end 101 and a second front end 110. Although FIG. 1 illustrates single instances of the constituent components of the SDR system 100, the SDR system 100 may include any number of constituent components. In certain embodiments, FIG. 1 is a diagram of a software defined radio system with a degenerate component implemented using a machine learning model with two different temporal configurations.

The first front end 101 may include a radio-frequency front end circuit. By way of example, the RF front end may include an antenna 103, an amplifier 105, a tuner 107, and an analog-to-digital converter (ADC) 109. In certain embodiments, the RF front end may comprise ASIC hardware configured to receive one or more radio signals from the antenna 103. The amplifier 105 may include a power amplifier but is not limited to such an amplifier. The tuner 107 may include an RF tuner but is not limited to such a tuner. The ADC 109 may be configured to convert the one or more radio signals, as propagated from the antenna 103 through any of the amplifier 105 and/or the tuner 107, to the digital domain.

The second front end 110 may include a digital front end. By way of example, the second front end 110 may include an oscillator 111, a mixer 113, a network 115, a filter 117, and a signal processor 119. The oscillator 111 may include a digital local oscillator but is not limited to such an oscillator. The mixer 113 may include a digital mixer but is not limited to such a mixer. The network 115 may include an observer neural network but is not limited to such a network. The filter 117 may include a low pass filter but is not limited to such a filter.

The second front end 110 may be implemented on an FPGA, but is not limited thereto. In certain embodiments, it may be implemented by any number of processors. In certain embodiments, the processor, such as a central processing unit (CPU), may be the central processing unit that is configured to perform calculations and logic operations to execute one or more programs. The processor, alone or in conjunction with the other components, may be an illustrative processing device, computing device, processor, or combinations thereof, including, for example, a multi-core processor, a microcontroller, a field-programmable gate array (FPGA), or an application-specific integrated circuit (ASIC). The processor may include any processing component configured to receive and execute instructions (such as from a non-transitory, processor readable storage medium). In some embodiments, the processor may include a plurality of processing devices.

The non-transitory, processor readable storage medium may contain one or more data repositories for storing data that is received and/or generated. The non-transitory, processor readable storage medium may be any physical storage medium, including, but not limited to, a hard disk drive (HDD), memory (e.g., read-only memory (ROM), programmable read-only memory (PROM), random access memory (RAM), double data rate (DDR) RAM, flash memory, and/or the like), removable storage, a configuration file (e.g., text) and/or the like. While the non-transitory, processor readable storage medium may be depicted as a local device, it should be understood that the non-transitory, processor readable storage medium may be a remote storage device, such as, for example, a server computing device, cloud-based storage device, or the like.

The processor may be configured to transmit and receive any type of data via a network. This network may be one or more of a wireless network, a wired network, or any combination of wireless network and wired network, and may be configured to operably communicate with any and all of the constituent components of the SDR system 100. For example, network may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network may include, without limitation, telephone lines, fiber optics, IEEE Ethernet 802.3, a wide area network, a wireless personal area network, a LAN, or a global network such as the Internet. In addition, the network may support an Internet network, a wireless communication network, a cellular network, or the like, or any combination thereof. The network may further include one network, or any number of the exemplary types of networks mentioned above, operating as a stand-alone network or in cooperation with each other. The network may utilize one or more protocols of one or more network elements to which they are communicatively coupled. The network may translate to or from other protocols to one or more protocols of network devices. Although the network is depicted as a single network, it should be appreciated that in one or more aspects, the network may include a plurality of interconnected networks, such as, for example, the Internet, a service provider's network, a cable television network, corporate networks, such as credit card association networks, and home networks. As further depicted in FIG. 1, a trojan 121 may be present in the SDR system 100, which in turn may be detected and mitigated by the SDR system 100. The second front end 110 may be configured to handle a sample rate conversion and signal processing via the signal processor 119.

In certain embodiments, since the second front end 110, such as the digital front end portion of the SDR system 100, may be implemented on some form of embedded system (e.g., SoC or FPGA), it may susceptible to all of the vulnerabilities of embedded systems (e.g., trojans, design errors, SEUs, etc.). For example, this system may be implemented on an FPGA using compromised third party SDR component modules. A malicious agent may have inserted a trojan within the third party SDR component modules that disables the output of a component after a certain amount of time has passed. In this scenario, a traditional approach to mitigating this issue, such as TMR, would not be effective because the redundant copies of the trojan infected circuit would be compromised as well. The system designer may opt to implement the third party SDR component modules themselves as this would make the system more trustworthy, but this, in turn, adds complexity and time to the development process.

Since the components of a computer system can be described as a continuous function that transforms some input into some output over time, if shown enough examples, the ANN disclosed here may be configured to effectively learn the functionality of any software or hardware component. Therefore, the ANN may be configured to create trustworthy approximations of SDR component modules, including but not limited to third party SDR component modules, and implement a new form of redundancy (i.e., ACD).

The process of implementing ACD within a system may be broken down into the following procedure: train an ANN on the input and output signals of a component until system loss is sufficiently low (e.g., until the system loss is at or below a predetermined threshold value); periodically compare the output of the component to the output of the trained ANN (degenerate component); if or when there is a difference between input and output signals that exceeds the predetermined threshold value, replace the component output with the degenerate component output. This approach to fault tolerance includes benefits over a traditional redundancy approach: here, a single ANN may be used as a degenerate component for practically any size component within a system, making the degenerate component scalable and more efficient than the original component. Also, the ANN may be developed without third parties, thereby making the output more trustworthy, given the network is trained sufficiently. Still further, the ANN may have a degree of intrinsic fault tolerance, meaning the degenerate component may still function properly even if trained on some amount of compromised or corrupted data. In certain embodiments, the determination of system loss as being sufficiently low may depend on, including but not limited to, an application, a data type, and an amount of error that the SDR system 100 may tolerate, or any combination thereof. For example, the loss may include less than, equal to, or greater than a first predetermined threshold. In embodiments, a first predetermined threshold may be a user-defined parameter fed into the SDR system 100. In a specific embodiment, the first predetermined threshold may be 1%, such that an ANN system is considered sufficiently trained when system loss is less than or equal to 1%. Still further, the replacement may be triggered when the difference between the outputs (relative to the original component and the degenerate component) exceeds a second predetermined threshold. In embodiments, the second predetermined threshold may be another user-defined parameter fed into the SDR system 100. In a specific embodiment, the second predetermined threshold may be 1%, such that replacement is triggered when the difference between the outputs is greater than 1%. It is understood that such percentages and thresholds are non-limiting, and need not be user-defined.

In certain embodiments, any of the components within the SDR system 100 may be compromised. By way of example, components within a digital down-converter (DDC) may be selected to simulate a DOS attack. For example, the DDC may include the mixer 113 and the filter 117. In this threat model, when the trojan 121 is triggered, an output of an affected component may be disabled (i.e., the output will be zero). To understand what the input and output waveforms of the components within the DDC would normally look like, its functionality may be defined.

Most ADCs today may sample data at a very high rate with speeds reaching 20 Giga samples per second. Because signal processing may be done sequentially (for example, each sample to be processed before the next), a very high-speed digital signal processor (DSP) may be needed to maintain the throughput of the system. This is unnecessary since the data being received is usually much lower in frequency than what is being processed. Therefore, the signal may be down-converted to reduce the DSP speed requirements while also preserving the original data being transmitted. Down-conversion may also be used as a technique for demodulating amplitude modulated signals, which creates a favorable scenario from which to derive data. The SDR system 100 may be used to test a model, as described above.

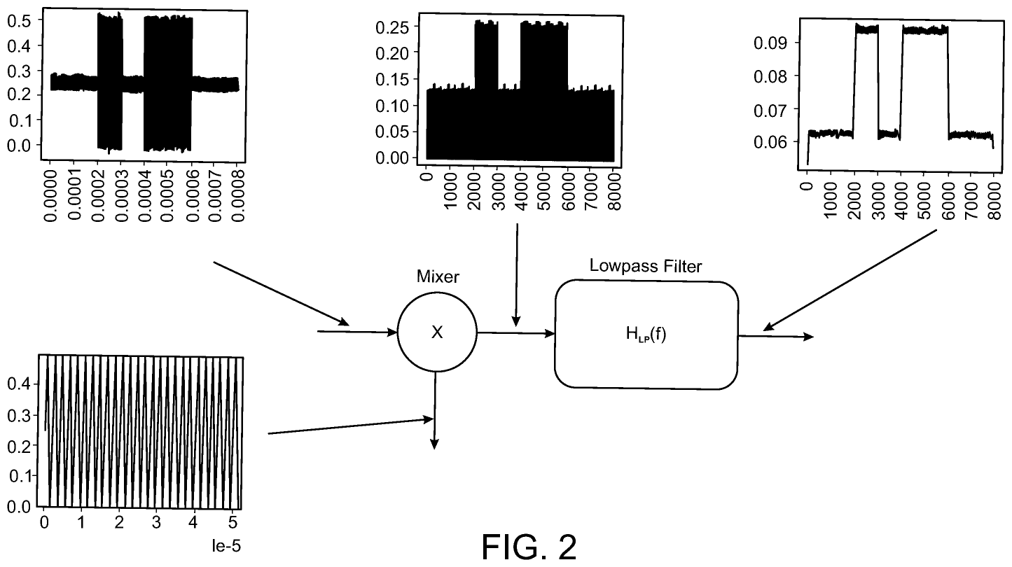

FIG. 2 depicts a modulated signal going through each stage of a DDC. FIG. 2 may reference any and all components as previously described above with respect to FIG. 1 or any other figure. In certain embodiments, FIG. 2 is a visual representation of an on-off keying modulated signal going through each stage of a digital down-converter.

In certain embodiments, on-off keying (OOK) is a very simplistic form of amplitude modulation (AM), which may be used to modulate binary data. The modulated signal may include an OOK signal. The presence of a carrier wave may denote a “1” whereas the absence of a carrier wave may denote a “0”. In certain embodiments, and as previously explained with reference to FIG. 1, the DDC may include the mixer 113 and the filter 117. The original signal may be multiplied by a sine wave with the same frequency as the carrier wave. The resulting signal may have an envelope that matches the original signal. The low pass filter may then be configured to attenuate a high frequency component resulting in a demodulated binary signal. By knowing what the data looks like at each stage of the DDC, training data may be generated for the ANN for both the mixer 113 and filter 117 components. AM audio data may also be demodulated through the same process of down-conversion, which provides a more complex dataset to test the model against as well.

In certain embodiments, a plurality of datasets may be generated and utilized in simulations using, for example, Python: OOK low pass filter; OOK mixer; OOK DDC including the low pass filter and the mixer; and an audio low pass filter. As previously explained, the mixer may refer to mixer 113, and the filter may refer to the filter 117. By way of example, Python was chosen to simulate the SDR system and ANN due to its simplistic syntax and a variety of libraries, which allow for rapid prototyping. It also supports the TensorFlow library, which streamlines the process of experimenting with different model architectures and hyperparameters. The OOK dataset may be generated using a Python script that may modulate a random array of bits using OOK modulation. The following parameters may be selected to generate data that may accurately model the SDR system 100: carrier wave frequency: 500 kHz; signal period: 100 s; sample rate: 10 MHz. In certain embodiments, the mixer component may be simulated by multiplying the OOK modulated signal by a sine wave of equal length and frequency to that of the carrier wave. In certain embodiments, the low pass filter component may be modeled using SciPy. The cutoff frequency may be set to 100 kHz in order to effectively filter out the high frequency component of the carrier wave. With this data generation script, training and testing datasets may be generated for each component in the SDR system 100, such as the mixer 113, filter 117, and both of these components simultaneously. In certain embodiments, the ANN may be configured to approximate the functionality of the entire DDC without the need for the additional oscillator input of the mixer 113.

The model may be trained using this data until the loss is sufficiently low, as previously explained with respect to the first predetermined threshold, which may imply that the model has learned the behavior of the component. In a real system, the model may either be trained online, assuming the SDR component is functioning properly, or offline using simulated data to ensure that the model learns the functionality of the component that is uncompromised. Considering the scenario in FIG. 1 where the filter 117 is attacked by a trojan 121, the trained model may be configured to detect the trojan 121 by comparing a measured output of the filter 117 component to an actual or expected output of the filter 117 component and may replace the component's output upon detection of an anomaly. In certain embodiments, the detection of the anomaly may be relative to the comparison between the measured and expected or actual output of the SDR component, and a third predetermined threshold. In embodiments, the third predetermined threshold may include yet another user-defined parameter that can be tunable based on the design of the SDR system 100 and allowed error tolerances. In a specific embodiment, the third predetermined threshold may be 1%, such that replacement is triggered when the difference between the measured output and the expected or actual output is greater than 1%. As will be further explained, the ANN model architecture may be configured to achieve this functionality.

In certain embodiments, the ANN model may be trained on a dataset containing N input and output samples from the component, where each time series measurement may be denoted as x(t) and y(t), respectively. The input to the model is shaped as such: [x(t); x(t−1), . . . , x(t−T)], where T is the length of previous measurements from the current sample. If a component has a plurality of inputs, the inputs may be appended together as such: [x₁(t); x₁(t−1), . . . , x₁(t−T), x₂(t), x₂(t−1), . . . , x₂(t−T)].

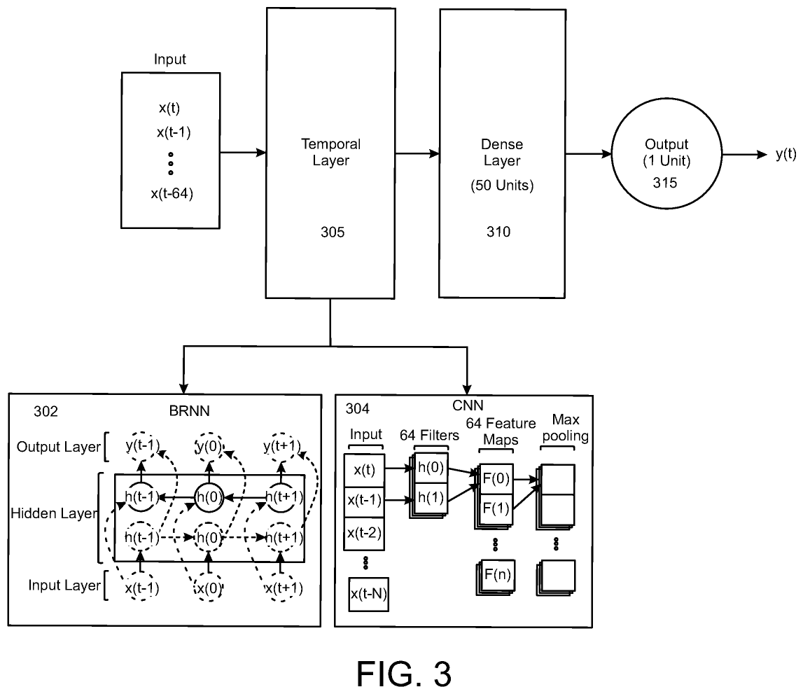

Unlike other ANN models, this model includes a plurality of layers, as depicted in FIG. 3: a temporal layer 305, a fully connected layer 310, and an output layer 315. These layers 305, 310, 315 may all be connected sequentially. FIG. 3 may reference any and all components as previously described above with respect to FIG. 1, FIG. 2, or any other figure. In certain embodiments, FIG. 3 is a block diagram of the model architecture showing the structural difference between the two temporal layer implementations, as will be discussed below.

For the temporal layer 305, evaluation of a plurality of neural network implementations was performed, here a bidirectional recurrent neural network (BRNN) 302 and 1-dimensional convolutional neural network (CNN) 304. It is understood that evaluation of neural networks is not limited to these types, and that other types of neural networks may be used. Both architectures of the neural networks 302, 304 are well suited to handle the task of time series data estimation, each having their own advantages. The output of the temporal layer 305 may be fed into the fully connected layer 310, such as a dense layer, which may include 50 neurons. Both the recurrent and fully connected 310 layers may use a rectified linear unit (ReLU) activation function (i.e., f(x)=max(0; x)), to improve the training of the deep neural network. The output of this layer 310 may then be fed into the output layer 315, which may include a single neuron using the linear activation function (i.e., f(x)=x). This output, denoted as \hat{ }y(t), represents the network's prediction of what the component would output based on the previous input samples.

In certain embodiments, the BRNN 302 may be configured for using time series data because the neurons for each time step are connected sequentially, forwards and backwards, which allows for the model to discover long-term temporal relationships in the data. This is beneficial since the model may be trained on a black box SDR component's input and output signals and it needs that temporal relationship to gain context as to what the component is doing to the signal. In certain embodiments, the BRNN 302 may be implemented using long short-term memory (LSTM) because of its ability to mitigate the vanishing gradient issue associated with traditional RNN implementations. Because the data may be evaluated in real-time, as opposed to looking forward in time, the model may look at buffer of input samples forward and backwards. The BRNN 302 may be configured to compute a vector of outputs [f(t); f(t−1), . . . , f(t−T)] using the following equation: f(t)=v^{f}*h^{f}(t)+v^{b}*h^{b}(t)+c, where h^{f}(t) and h^{b}(t) denote the forward and backward hidden layer activations, v^{f} and v^{b} denote the vector of weights connecting the hidden layer neurons to the output neurons, and c denotes the bias of each output neuron.

In certain embodiments, the CNN 304 may also be evaluated, as it can achieve similar performance to BRNN 302 in less training time while also being more computationally efficient since, with CNN 304, the temporal relationship is not created though serially connected neurons but rather though the convolutions performed over the data which can be done in parallel. In this context, the following equation may describe the convolution process:

$$F ( n ) = {\sum }_{i} x ( t - i ) h ( i )$$

where x and h denote the input and filter vectors respectively, and F denotes the feature map resulting from the convolution. The CNN 304 may include M filters that are used to convolve the input, resulting in M feature maps. The feature maps may be fed into a pooling layer which downsamples the convolved data in order to reduce the computational complexity of the model. In certain embodiments, max-pooling may be implemented to return the maximum value within a subsection of the convolved data. The output of the pooling layer may be then flattened and fed into the fully connected layer 310.

To train the model on an SDR component, N input and output samples may be collected, and the input may be normalized to a range of, for example 0 to 1, to ensure that model convergence. The model may be trained using a backpropagation through time algorithm. Each input in the dataset may be fed through the network to produce an output prediction. The output prediction may be compared to the actual output using a mean squared error (MSE) loss function, as described as:

$$MSE = \frac{1}{n} {\sum }_{i = 1}^{n} {( {y}_{i} - {\hat{y}}_{i} )}^{2}$$

Loss values may be used to compute a gradient which is then backpropagated into the network to update the weights and biases. Through experimentation, training the model in two phases and modifying the optimizer between phases was found to produce the best results for this application. The model may be trained using the Adadelta optimizer until the loss converges. Then the model may be trained using, for example, the Adaptive Moment Estimation (Adam) optimizer, once again, until the loss converges. In certain embodiments, the Adadelta optimizer may require no manual learning rate tuning and may be used to direct the loss of the model to a local minimum. The Adam optimizer may then be used with a very small learning rate (10⁻⁶) to help further reduce the loss of the network without overfitting. Once the loss is below a predetermined threshold, it may be such that, given a buffer of input samples, the model may be configured to accurately reproduce output signals of the component it was trained on.

In certain embodiments, increasing the input sample size may provide the ANN more context to make decisions but lessens the performance due to the increase in input data being processed. Increasing the batch size may significantly increase the evaluation speed of both the BRNN and CNN 302, 304 models but produce opposite outcomes in terms of network accuracy. The BRNN 302 models may become less accurate (i.e., the loss is greater than normal) when increasing the batch size while the CNN 304 models may become more accurate. This may make the CNN 304 model more appealing as the increase in speed is accompanied by an increase in accuracy. While the best performing BRNN 302 model may be able to achieve greater accuracy than the best CNN 304 model, the CNN 304 model may be significantly faster. In certain embodiments, the CNN 304 model may or may not be a superior implementation as compared to the BRNN 302 model.

In certain embodiments, the CNN 304 model trained on OOK modulated data may show a significant dip at the carrier wave frequency (500 kHz) but then increase back to around −20 dB. In contrast, the CNN 304 model trained on the audio dataset may have a more gradual downward trend that also returns to around −20 dB at higher frequencies. The BRNN 302 models may all have a gradual downward trend, but it was discovered that at lower frequencies they produced significant distortions in the output signal which is not desirable. The CNN 304 models did not produce distortions in the output signals at any frequency, which further demonstrates the CNN architecture's superiority over the BRNN 302 architecture for this application.

In certain embodiments, implementing the BRNN 302 models may cause buffer overflow issues with the SDR circuit. For example, the BRNN 302 model may be less computationally efficient and SDR systems may have strict timing requirements. The CNN 304 model implementation may allow for the SDR system to function, and also detect a DoS trojan. However, the system may crash due to audio underrun errors. This may be caused by low network throughput and also due to the replacement of a computationally simplistic component with an ANN that is more computationally complex. To mitigate this issue, signal decimation and interpolation may be utilized. In certain embodiments, decimation may refer to a signal processing technique that involves reducing a sample rate of a signal. This allows the model to process less samples at a time but at the sacrifice of signal quality due to a distortion effect caused by aliasing. With the CNN 304 model, a decimation factor of 10-6 may be needed to allow the SDR to maintain its throughput without audio underrun errors. However, the sound quality may be audibly muffled and difficult to understand due to the high amount of aliasing. To reduce the amount of aliasing required to allow the SDR to maintain its throughput, an amount of filters used in the CNN 304 model may be reduced. With experimentation, it was found to achieve a decimation factor 3 (i.e., the audio was clear enough to understand) implementing a CNN 304 model with four filters.

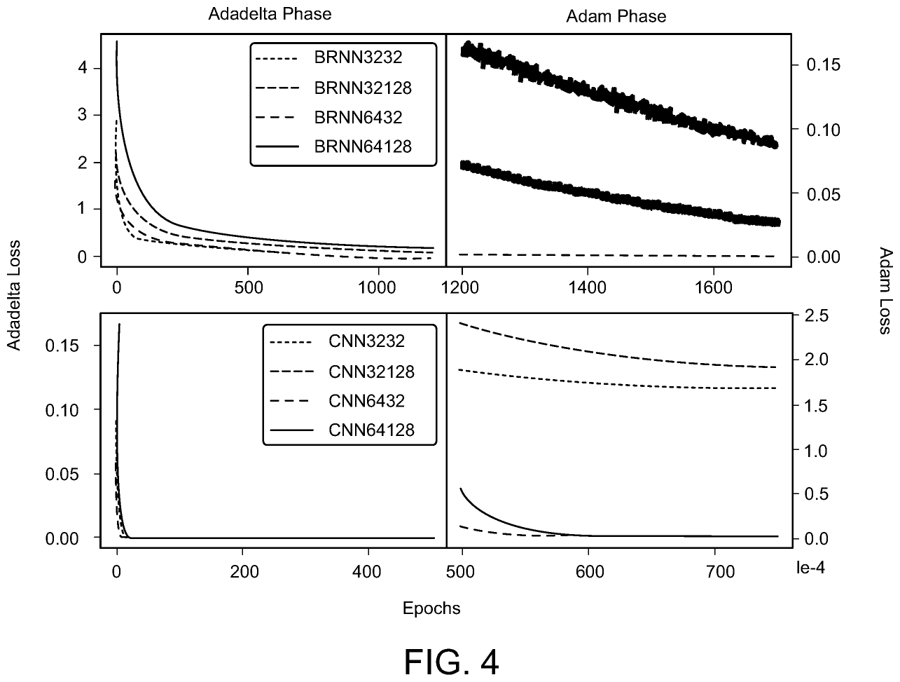

As shown in FIG. 4, once the loss of the model has converged to a low value, as previously explained above with respect to the first threshold, confidence in the model's ability to reproduce the component's output may be gained. Therefore, when the trained model is configured to monitor the component, a small loss value between the component and model outputs may indicate that the component is functioning properly. On the other hand, if the loss increases abruptly, this may signal that there is something wrong with the component, whether a trojan has been triggered and caused unprecedented damage to the component in question or if the component is no longer functional due to a variety of issues that may occur during a system's lifetime (e.g., aging, environmental parasitics, anomalies, etc.). In certain embodiments, the loss increasing abruptly refers to exceeding a predetermined threshold, for example, exceeding a predetermined threshold of 1%. It is understood that this predetermined threshold is not limited to such a percentage, and that it may or may not be user-defined, as with the other aforementioned predetermined thresholds. FIG. 4 may reference any and all components and operations as previously described above with respect to FIG. 1, FIG. 2, FIG. 3, or any other figure. In certain embodiments, FIG. 4 is a series of graphs showing set of loss over time plots for each of the model variations trained on the OOK dataset.

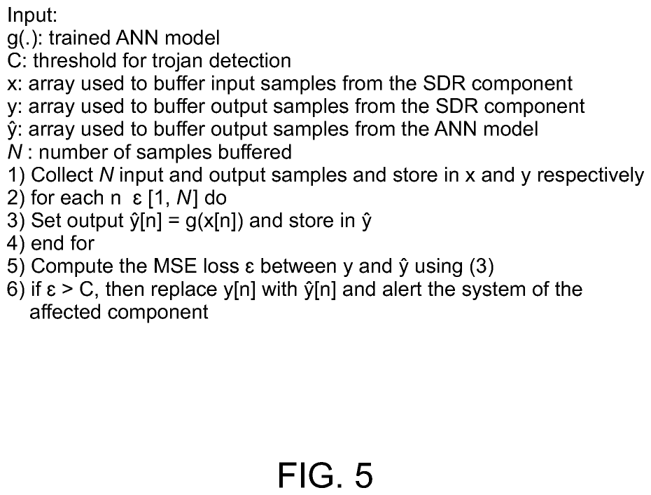

Considering that the ANN may be configured to compute the output signals of the component accurately, at this point the nonfunctional component may be replaced with the ANN. The steps of an exemplary algorithm are outlined in FIG. 5. FIG. 5 may reference any and all components and operations as previously described above with respect to FIG. 1, FIG. 2, FIG. 3, FIG. 4, or any other figure. In certain embodiments, FIG. 5 is a list of the steps the ANN uses to determine whether to replace the component in the system affected by a hardware trojan.

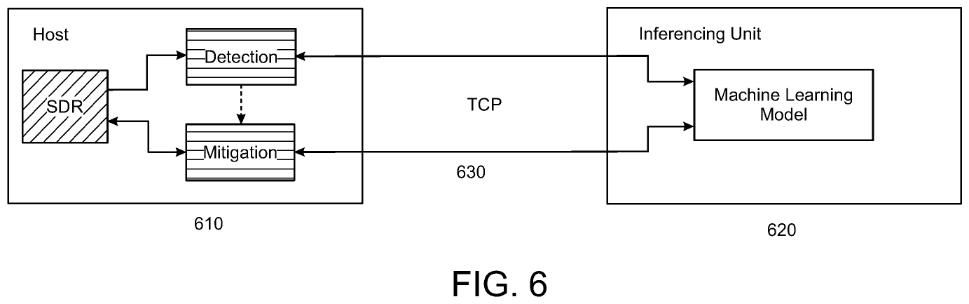

FIG. 6 depicts a block diagram of a hardware configuration of a system. In certain embodiments, FIG. 6 illustrates a hardware configuration of a software defined radio system, such as the SDR system 100, as previously described. Although FIG. 6 illustrates single instances of the constituent components of the system 600, the system 600 may include any number of constituent components.

In certain embodiments, data may be transmitted between a host 610 and an inferencing unit 620. By way of example, the host 610 may include the SoC hosting the SDR, and the inferencing unit 620 may include a device hosting the ANN. In certain embodiments, the host 610 and the inferencing unit 620 may be configured to communicate with each other and transmit and receive data using, for example, a transmission control protocol (TCP) 630 over Ethernet. In certain embodiments, the host 610 may include an Nvidia Jetson Nano®, and the inferencing unit 620 may include a MacBook Pro®. However, it is understood that the host 610 and the inferencing unit 620 are not limited to such configurations, and that other types of configurations may be instead utilized for implementation, including any device that is configured to support a communication interface, such as a fast communication interface. By way of example, this may include Ethernet, PCIe, etc.

In certain embodiments, ACD may be implemented using two separate custom OutOfTree modules that can be written in, for example, C++ or Python, including a “detection” OOT module, and a “mitigation” block OOT module. When the SDR circuit is functioning normally, the detection block may be configured to buffer input and output samples taken from the component being observed and send the input samples to the inferencing unit 620. The inferencing unit 620 may be configured to utilize the ANN to perform inferencing on the input samples and send the output back to the detection block. The detection block may then be configured to compute the MSE between the output from the model and the buffered output signals from the component. If the MSE exceeds the predefined threshold, the detection block may be configured to send a message to the mitigation block to enable its output. When the trojan is detected, the mitigation block may be configured to buffer input samples taken from the component and send the samples to the inferencing unit 620. The inferencing unit 620 may be configured to use the model to perform inferencing on the samples and send the output back to the mitigation block to be fed back into the SDR circuit which may allow the SDR to maintain its functionality while being affected by a DoS trojan.

The systems and methods disclosed herein are configured for prevention and mitigation of malicious or unintentional disruption of computer hardware and software operation through the use of machine learning and artificial intelligence. Still further, the systems and methods are configured for modeling SDR behavioral modules in real time using ANNs. As disclosed herein, adaptive component-level degeneracy (ACD) involves the training of an ANN on the input and output signals of a “black-box” component within an SDR system. Once the ANN has learned the component functionality sufficiently, the ANN may be configured to detect when the component is malfunctioning by comparing its own output to the output of the component. If the component is malfunctioning, the ANN may be configured to autonomously replace the component within an SDR module in real-time to maintain its functionality, thus making the component artificially degenerate. As will be further discussed, the systems and methods disclosed herein may also evaluate performance of two different ANN architectures (the bidirectional recurrent neural network (BRNN) and the convolutional neural network (CNN)) at modeling various SDR components within a simulated SDR system. Still further, the systems and methods disclosed herein may be implemented within a real-time SDR system implemented with GNU Radio Companion (GRC) on an SoC device.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some aspects may be combined in some other aspects. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A detection and mitigation system comprising:
an artificial neural network (ANN) that is configured to create a degenerate component that is functionally identical but structurally different from an original component in the system and produces the same output as the original component,
wherein the ANN is configured to compare outputs of the degenerate component to outputs of the original component, and
wherein the ANN is configured to replace the outputs of the original component with the outputs of the degenerate component when a difference between the outputs of the original component and the outputs of the degenerate component is detected.

2. The detection and mitigation system of claim 1, wherein the system comprises an embedded computer system.

3. The detection and mitigation system of claim 1, wherein the ANN is configured to alert the detection and mitigation system of a faulty, a failed, or a compromised original component.

4. A method of detecting a component failure in a digital system comprising the steps of:
training an artificial neural network (ANN) on buffered input and output samples of an original component within a system such that the ANN is configured to produce a degenerate component, the degenerate component configured to generate the same outputs as the original component;
comparing the outputs from the original component to outputs of the degenerate component during actual component operation; and
in the event of a failure of the original component, replacing the original component with the degenerate component.

5. The method of claim 4, wherein after the original component is replaced by the degenerate component, the ANN is configured to produce a new degenerate component, wherein the new degenerate component is configured to generate the same outputs as the original component.

6. The method of claim 5, wherein the ANN is configured to dynamically produce the degenerate component.

7. The method of claim 4, wherein the ANN is configured to produce a plurality of the degenerate components.

8. The method of claim 4, wherein the digital system includes a software defined radio system.

9. The method of claim 4, wherein the original component includes an integrated circuit comprising a field-programmable gate array or a system-on-a-chip.

10. The method of claim 9, where the original component fails due to a fault.

11. The method of claim 10, wherein the fault is selected from at least one of a single-event upset error, a hardware trojan, genuine design error, or any combination thereof.

12. The method of claim 4, wherein the buffered input and output samples of the original component are normalized to a predetermined range for model convergence.

13. The method of claim 4, further comprising comparing the outputs from the original component to outputs of the degenerate component using a mean squared error loss function.

14. A non-transitory, computer-readable medium comprising instructions that, when executed by at least one processor, cause the at least one processor to perform one or more operations comprising:
training an artificial neural network (ANN) on buffered input and output samples of an original component within a system such that the ANN is configured to produce a degenerate component, the degenerate component configured to generate the same outputs as the original component;
comparing the outputs from the original component to outputs of the degenerate component during actual component operation; and
in the event of a failure of the original component, replacing the original component with the degenerate component.

15. The non-transitory computer-readable medium of claim 14, wherein after the original component is replaced by the degenerate component, the ANN is configured to produce a new degenerate component, wherein the new degenerate component is configured to generate the same outputs as the original component.

16. The non-transitory computer-readable medium of claim 15, wherein the ANN is configured to dynamically produce the degenerate component.

17. The non-transitory computer-readable medium of claim 14, wherein the ANN is configured to produce a plurality of the degenerate components.

18. The non-transitory computer-readable medium of claim 14, wherein the digital system includes a software defined radio system.

19. The non-transitory computer-readable medium of claim 14, wherein the original component includes an integrated circuit comprising a field-programmable gate array or a system-on-a-chip.

20. The non-transitory computer-readable medium of claim 19, where the original component fails due to a fault.
